(19) United States
(12) Patent Application Publication
(10) Pub. No.: US 2026/0154527 A1
(43) Pub. Date: Jun. 4, 2026

(54) METHOD AND DEVICE FOR STRUCTURAL DAMAGE DETECTION IN NONLINEAR SYSTEM

(71) Applicant: Wuhan Institute of Technology, Wuhan (CN)

(72) Inventors: Hanxin Chen, Wuhan (CN); Yongting Chen, Wuhan (CN); Qinglai Wei, Wuhan (CN); Wenrui Yang, Wuhan (CN)

(21) Appl. No.: 19/376,895

(22) Filed: Nov. 1, 2025

Related U.S. Application Data
(63) Continuation of application No. PCT/CN2025/127440, filed on Oct. 14, 2025.

(30) Foreign Application Priority Data
Nov. 29, 2024 (CN) 202411732356.4

(51) Int. Cl. G06N 3/044; G06F 18/21; G06N 3/08

(52) U.S. Cl. CPC G06N 3/044; G06F 18/217; G06N 3/08

(57) ABSTRACT

A method and a device for structural damage detection in a nonlinear system are provided. The method includes: applying an excitation force to a specimen to be detected to induce a vibration phenomenon in the specimen to be detected, and performing signal collection on the specimen to be detected by a laser vibrometer to obtain an excitation signal and a response signal; constructing, according to the excitation signal, the response signal and imported order combinations, initial NARX models corresponding to different orders; selecting, based on an Akaike information criterion, a target NARX model corresponding to an optimal order combination; optimizing the target NARX model to obtain a NARX model to be detected; comparing order information of the NARX model to be detected with order information of a benchmark NARX model, and determining, based on an order comparison result, whether there is a defect in the specimen to be detected.

### TECHNICAL FIELD

The disclosure relates to the field of non-destructive detection technologies, and more particularly to a method and a device for structural damage detection in a nonlinear system.

### BACKGROUND

A nonlinear system is a system in which the change in output is not proportional to the change in input, characterized by a nonlinear relationship between input and output. Non-destructive detection refers to using the modern technology and equipment to inspect internal and surface defects in a specimen based on changes caused by internal structural abnormalities or defects, without damaging or affecting the use performance of the object being tested. In non-destructive detection of microcracks in a metal specimen, the presence of defects in the specimen can cause the mechanical behavior of the specimen to exhibit nonlinear characteristics. Nonlinear system parameter identification methods can capture these nonlinear features, thereby achieving defect detection and localization. However, different materials, structures, and testing conditions may require different nonlinear models for description.

Although there are currently several nonlinear models available, such as the Hammerstein model and the Wiener model, choosing an appropriate model remains challenging in practical applications. If the selected model does not fit a specific non-destructive detection problem well, it may lead to inaccurate identification results, affecting defect detection and evaluation.

### SUMMARY

The technical problem to be solved by the disclosure is to provide a method and device for structural damage detection in a nonlinear system in response to the shortcomings in the related art.

The technical solution of the disclosure to solve the above technical problems is as follows.

A method for structural damage detection in a nonlinear system includes the following steps:
applying an excitation force to a specimen to be detected by a modal force hammer to induce a vibration phenomenon in the specimen to be detected, and performing, when applying the excitation force, signal collection on the specimen to be detected by a laser vibrometer to obtain an excitation signal corresponding to the excitation force and a response signal corresponding to the vibration phenomenon in the specimen to be detected;
importing multiple order combinations; constructing, according to the excitation signal, the response signal and the multiple order combinations, initial nonlinear autoregressive with exogenous input (NARX) models corresponding to different orders; selecting, based on an Akaike information criterion, a target NARX model corresponding to an optimal order
combination of the multiple order combinations from the initial NARX models; and optimizing the target NARX model by a least squares method to obtain a NARX model to be detected; and comparing order information of the NARX model to be detected with order information of a benchmark NARX model to obtain an order comparison result, and determining, based on the order comparison result, whether there is a defect in the specimen to be detected.

In an embodiment, the method further includes: repairing or replacing, when determining there is the defect in the specimen to be detected, the specimen to be detected.

Another technical solution of the disclosure to solve the above technical problems is as follows.

A device for structural damage detection in a nonlinear system includes a signal collection module, a model construction module, and a defect detection module.

The signal collection module is configured to apply an excitation force to a specimen to be detected by a modal force hammer to induce a vibration phenomenon in the specimen to be detected, and perform, when applying the excitation force, signal collection on the specimen to be detected by a laser vibrometer to obtain an excitation signal corresponding to the excitation force and a response signal corresponding to the vibration phenomenon in the specimen to be detected.

The model construction module is configured to import multiple order combinations; construct, according to the excitation signal, the response signal and the multiple order combinations, initial NARX models corresponding to different orders; select, based on an Akaike information criterion, a target NARX model corresponding to an optimal order combination of the multiple order combinations from the initial NARX models; and optimize the target NARX model by a least squares method to obtain a NARX model to be detected.

The defect detection module is configured to compare order information of the NARX model to be detected with order information of a benchmark NARX model to obtain an order comparison result, and determine, based on the order comparison result, whether there is a defect in the specimen to be detected.

In an embodiment, each of the signal collection module, the model construction module, the defect detection module, the initial NARX models, the target NARX model, the NARX model to be detected, and the benchmark NARX model is embodied by at least one processor and at least one memory coupled to the at least one processor, and the at least one memory stores computer programs executable by the at least one processor.

The beneficial effects of the disclosure are as follows. The NARX models are established based on the input and output data of the specimen to be detected. The model order determination is performed using the Akaike information criterion, and parameter estimation is performed on the model obtained by the order determination using the least squares method to generate the optimal NARX model, thereby completing the modeling of the nonlinear system in which the specimen to be detected is located. The order information of the benchmark NARX model of the defect-free specimen and the order information of the NARX model to be detected of the specimen to be detected are used to generate parameter residuals. By comparing the set thresholds with the parameter residuals, it is determined whether the specimen has a defect, thereby achieving the purpose of defect detection.

### BRIEF DESCRIPTION OF DRAWINGS

FIG. 1 illustrates a flowchart diagram of a method for structural damage detection in a nonlinear system according to an embodiment of the disclosure.

FIG. 2 illustrates a structural diagram of the method for structural damage detection according to the embodiment of the disclosure.

FIG. 3 illustrates a schematic diagram of a specimen to be detected according to the embodiment of the disclosure.

FIG. 4 illustrates a module block diagram of a device for structural damage detection in a nonlinear system according to the embodiment of the disclosure.

### DETAILED DESCRIPTION OF EMBODIMENTS

The principles and features of the disclosure are described below in conjunction with the accompanying drawings. The embodiments given are only for the purpose of explaining the disclosure and are not intended to limit the scope of the disclosure.

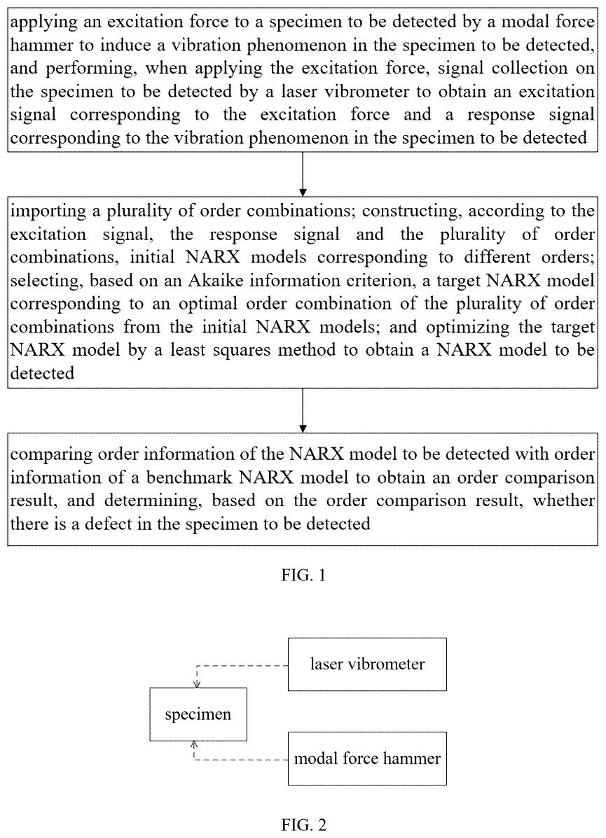

As shown in FIG. 1, an embodiment of the disclosure provides a method for structural damage detection in a nonlinear system, including the following steps:
applying an excitation force to a specimen to be detected by a modal force hammer to induce a vibration phenomenon in the specimen to be detected, and performing, when applying the excitation force, signal collection on the specimen to be detected by a laser vibrometer to obtain an excitation signal corresponding to the excitation force and a response signal corresponding to the vibration phenomenon in the specimen to be detected;
importing multiple order combinations; constructing, according to the excitation signal, the response signal and the multiple order combinations, initial NARX models corresponding to different orders; selecting, based on an Akaike information criterion, a target NARX model corresponding to an optimal order combination of the multiple order combinations from the initial NARX models; and optimizing the target NARX model by a least squares method to obtain a NARX model to be detected; and
comparing order information of the NARX model to be detected with order information of a benchmark NARX model to obtain an order comparison result, and determining, based on the order comparison result, whether there is a defect in the specimen to be detected.

It should be noted that, since the modal force hammer is used to apply the excitation force to the specimen to be detected to cause the specimen to be detected to vibrate, this force signal is the excitation signal of the specimen to be detected. The vibration displacement function of the specimen to be detected under the corresponding force signal is also referred to as the response function (i.e., the response signal). Since the output change of the specimen to be detected is not proportional to the input change, the specimen to be detected is regarded as a nonlinear system.

In the embodiments of the disclosure, a nonlinear model is constructed and optimized using the signal data of the specimen to be detected, enabling the nonlinear model to accurately represent the structural characteristics of the specimen to be detected, thereby determining whether the specimen to be detected has the defect. Since a micro-defect on the specimen can produce nonlinear effects, the model of the nonlinear system in which the specimen is located is established by analyzing the excitation signal and the response signal, thus determining whether the structure contains a defect. In other words, by utilizing the nonlinear effects produced by the specimen to be detected and constructing a nonlinear model with data that can express the nonlinearity of the specimen to be detected, and then optimizing the model parameters to make the model more accurately represent the characteristics of the specimen, it can be determined that whether the specimen to be detected has the defect.

In an embodiment, the applying an excitation force to a specimen to be detected by a modal force hammer to induce a vibration phenomenon in the specimen to be detected, and performing, when applying the excitation force, signal collection on the specimen to be detected by a laser vibrometer to obtain an excitation signal corresponding to the excitation force and a response signal corresponding to the vibration phenomenon in the specimen to be detected includes the following steps.

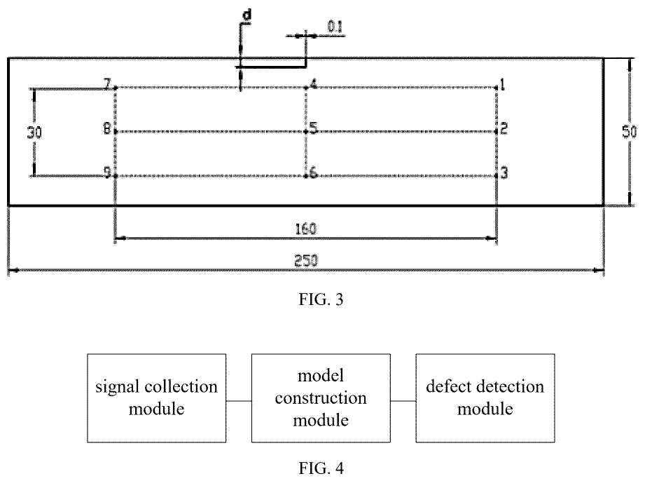

As shown in FIGS. 2-3, a common aluminum alloy thin plate with a length of 250 millimeters (mm), a width of 50 mm, and a thickness of 2 mm is selected as the specimen to be detected. A micro-crack with a width (d) of 0.1 centimeters (cm) is created on the specimen to be detected, and the specimen to be detected is fixed with a fixture. A region with a length of 160 mm and a width of 30 mm is selected on the specimen to be detected, and 9 test touch points are set in the region. The equipment used includes the modal force hammer connected to the JULIGHT laser vibrometer, a control unit with a data acquisition card, a vibration signal management (VSM)-TEST signal processing platform, and the laser controller (with an operating interface of Vibro Remote Console), etc. The modal force hammer applies the excitation force to the specimen to be detected to cause the specimen to be detected to vibrate, and the JULIGHT laser vibrometer records the vibration of the specimen to be detected in real time, and collects the input and output signals of the specimen to be detected.

Based on the dimensions, material, and metal plate defect range of the specimen to be detected, the laser focus is set through the laser controller, and the appropriate relevant parameters of the laser vibrometer acquisition system (including the laser focus, acquisition channels, a sampling frequency, trigger setting, and a preprocessing function) are selected as follows.

The laser focus is set. The control unit of the laser vibrometer with a data acquisition card sets the basic parameters of the laser vibrometer signal channels based on the basic data of the force hammer. The channel one is set as the input channel with a sensitivity of 2.42 millivolts per newton (mV/N), and the channel two is set as the output channel. Based on the dimensions, material, and metal plate defect range of the specimen to be detected, the laser controller sets a sampling frame rate of the laser vibrometer acquisition system to 5.12 kilohertz (kHz), selects 1600 spectral lines, and sets a bandwidth of 2 kHz. The linear averaging mode excitation is used, with a trigger delay set to −20 milliseconds (ms), a trigger threshold of 0.4%, and a trigger hysteresis of 0.2%. The VSM-TEST signal processing platform of the laser vibrometer is used to record the vibration of the specimen to be detected in real time. The window function of the input signal is set to a rectangular window, and the window function of the output signal is set to an exponential window with a main window offset of 5 ms and a decay constant of 100 ms. In the preprocessing stage, a high-pass filter is applied to the signal with a first 3-decibel (dB) frequency of 5 Hz and a second 3 dB frequency of 1.2 kHz to add the corresponding window function to the signal and perform preliminary signal denoising and other preliminary processing.

Based on the detection parameters of the laser vibrometer, the format of the test plan table is set to the excitation signal in the negative direction of the Z-axis and the response signal in the positive direction of the Z-axis. The test plan table is set according to the dimensions of the specimen to be detected, and the input excitation signal and the output response signal are collected. After the test is completed according to the test plan table, the response signal and the excitation signal can be exported.

It should be understood that, based on the determined size of the specimen to be detected, the number and arrangement of the detection touch points of the laser vibrometer on the specimen to be detected are selected. The hammer excitation is applied to the specimen to be detected in sequence according to the test order in the set test plan table, and the response signal and the excitation signal of each time period are collected by the signal collector of the laser vibrometer.

In an embodiment, before step of importing the multiple order combinations, the method further includes the following steps.
the range for the autoregressive order and the range for the exogenous input order are set. Corresponding orders are obtained from these ranges according to the set combination parameters to form the multiple order combinations.

Alternatively, the combinations of autoregressive orders and exogenous input orders are defined to obtain the multiple order combinations.

One set of order combinations could have autoregressive orders set as [1, 2, 3] and exogenous input orders set as [1, 2].

In an embodiment, each order combination includes the autoregressive order and the exogenous input order.

The constructing, according to the excitation signal, the response signal and the multiple order combinations, initial NARX models corresponding to different orders includes:
mapping, according to the autoregressive order and the exogenous input order of each of the multiple order combinations, the excitation signal to the response signal to obtain a corresponding one of the initial NARX models to thereby obtain the initial NARX models as follows:

$$y ( k ) = F [ y ( k - 1 ) , … , y ( k - {n}_{a} ) , u ( k - {n}_{b} ) , u ( k - {n}_{b} - 1 ) , … , u ( k - {n}_{b} - {n}_{k} ) ] + e ( k )$$

where y(k) represents the response signal (i.e., the response signal delay of the specimen to be detected at a k-th moment), u(k) represents the excitation signal (i.e., the excitation signal delay of the specimen to be detected at the k-th moment), F[⋅] represents a nonlinear function, nₐ represents the autoregressive order, n_{b} represents a time delay, representing the time difference between the exogenous input (i.e., the excitation signal) and the output (i.e., the response signal), nₖ represents an exogenous input order, and e(k) represents a model error term; y(k−1) represents an output signal delay from one moment ago, y(k−nₐ) represents an output signal delay from nₐ moments ago, u(k−n_{b}) represents a lag of the input signal, with the actual influence of the input signal starting from a moment n_{b}, and u(k−n_{b}−nₖ) represents the input signal from nₖ moments ago (i.e., the delayed part of the input), with the actual influence of the input signal starting from the moment n_{b}.

Specifically, the NARX neural network is used to perform regression analysis on the excitation signal and the response signal. According to the set order combination, the excitation signal is mapped to the response signal to obtain the NARX model.

Generally, the NARX model is widely used in black-box modeling of the nonlinear system to represent the relationship between the input and output signals of the nonlinear system. The current output signal is composed of a weighted combination of past input and output signals. The general expression of the NARX model is as follows:

$$y ( k ) = F [ y ( k - 1 ) , … , y ( k - {n}_{a} ) , u ( k - 1 ) , … , u ( k - {n}_{k} ) ] + e ( k )$$

where y(k) represents the output signal of the nonlinear system, u(k) represents the input signal of the nonlinear system, F[⋅] represents the nonlinear function, nₐ represents the autoregressive order, nₖ represents the exogenous input term order, and e(k) represents the model error term, usually assumed to be white noise; y(k−1) represents an output signal delay of the previous output, y(k−nₐ) represents output signal delay from nₐ previous outputs, u(k−1) represents an input signal delay of the previous input, and u(k−nₖ) represents the input signal delay from nₖ previous inputs.

It should be understood that both the excitation signal and the response signal have temporal information (both include signals at k moments). Using multiple delayed input and output signals can better capture the dynamic behavior and nonlinear relationships of the nonlinear system of the specimen to be detected. The NARX neural network is a type of neural network based on the autoregressive model, which has the ability to model time series and is suitable for prediction and time series analysis. The input sequence is mapped to the output sequence through regression analysis, and previous outputs and current inputs are used to predict the current output. The NARX model includes an autoregressive (AR) term and an exogenous (EX) input term. The autoregressive term represents a lagged value of the output, while the exogenous term represents an external input variable that may affect the output. The time delay in the NARX neural network refers to when processing time series data, the time difference between when the input data reaches the neuron and when the neuron responds with an output.

In the embodiment of the disclosure, the NARX neural network is a powerful tool for structural damage detection. The NARX model combines the advantages of traditional autoregressive models and neural networks, and can handle and predict the behavior of the nonlinear system.

In an embodiment, the selecting, based on an Akaike information criterion, a target NARX model corresponding to an optimal order combination of the plurality of order combinations from the initial NARX models includes:
acquiring parameters of the initial NARX models respectively to obtain model parameters of each of the initial NARX models, and performing calculation on the model parameters of each of the initial NARX models through a formula of the Akaike information criterion to obtain an Akaike information criterion value of each of the initial NARX models, where the formula of the Akaike information criterion is as follows:

$$AIC = 2 p - 2 ln ( L )$$

where AIC represents the Akaike information criterion value, p represents a number of the model parameters, and L represents a maximum likelihood estimation value; and
selecting one of the initial NARX models and the optimal order combination corresponding to a minimum value among the Akaike information criterion value of each of the initial NARX models to obtain the target NARX model corresponding to the optimal order combination.

The process of solving for the maximum likelihood estimate is as follows. Through the likelihood function, the model parameters of each initial NARX model are calculated, including: under the given observed data (the excitation signal and the response signal), by adjusting the model parameters so that the predicted probability distribution of the model is closest to the actual observed data (i.e., the likelihood function value is maximized), the function value (i.e., the maximum likelihood estimate corresponding to each initial NARX model) is obtained.

It should be understood that the Akaike information criterion is a minimal information criterion, an indicator for evaluating the optimal configuration comprehensively, and a weighted function of the fitting accuracy and the number of unknown parameters. The likelihood function is a function about the parameters of a statistical model, which measures the probability of observing the observed data x given the model parameters θ. When given the observed data x (i.e., the excitation signal and the response signal), the likelihood function L(θ|x) is numerically equal to the probability of the corresponding variable observed data given the parameters θ, expressed as:

$$L ( θ \vert x ) = P ( x \vert θ )$$

In the embodiment of the disclosure, the Akaike information criterion balances the fit goodness and the complexity of the model, and is used for model selection and comparison to choose the most suitable order combination from multiple order combinations, finding the model that best expresses the mapping relationship between the excitation signal and the response signal.

In an embodiment, before the optimizing the target NARX model by a least squares method to obtain a NARX model to be detected, the method for structural damage detection further includes:
solving, based on the model parameters of the target NARX model, the target NARX model to obtain a predicted response signal as follows:

$$\hat{y} ( k ; θ ) = {β}_{0} + {β}_{1} y ( k - 1 ) + … + {β}_{n} y ( k - {n}_{a} ) + {γ}_{1} u ( k - {n}_{b} ) + {γ}_{2} u ( k - {n}_{b} - 1 ) + … + {γ}_{n} u ( k - {n}_{b} - {n}_{k} )$$

where ŷ(k; θ) represents the predicted response signal, y(k) represents the response signal, u(k) represents the excitation signal, nₐ represents an autoregressive order, n_{b} represents a time delay, nₖ represents an exogenous input order, β₀ represents an intercept, βₙ represents an autoregressive coefficient, and γₙ represents an exogenous input coefficient.

In the embodiment, the closer the predicted value is to the actual value, the better the model fits and the more accurately the model represents the nonlinear system of the specimen to be detected. Therefore, the predicted value of the model is calculated based on the model parameters, and the predicted value is used to optimize the model parameters. This optimization process allows the prediction value of the model to progressively approach the actual value, thereby enabling the model to better represent the specimen to be detected.

In an embodiment, the optimizing the target NARX model by a least squares method to obtain a NARX model to be detected includes:
performing calculation on the response signal and the predicted response signal of the target NARX model through a target function formula to obtain a target function value, where the target function formula is as follows:

$$J ( θ ) = {\sum }_{k = 1}^{N} {( y ( k ) - \hat{y} ( k ; θ ) )}^{2}$$

where J(θ) represents the target function value, y(k) represents the response signal, ŷ(k; θ) represents the predicted response signal, and N represents a total model parameter number, and is an upper limit of the summation, also referred to as a total number of samples obtained in the signal acquisition process (i.e., the amount of signal data at different time steps); and
minimizing the target function value to obtain the NARX model to be detected.

In the embodiment of the disclosure, using the least squares optimization algorithm to optimize the model parameters not only improves the predictive performance of the model but also enhances the precision of the model, enabling the nonlinear model of the specimen to be detected to more closely approximate the actual output signal that has been collected.

In an embodiment, the minimizing the target function value to obtain the NARX model to be detected includes:
performing derivative calculation on the target function value through a derivative equation to obtain optimal model parameters, where the derivative equation is as follows:

$$ϑ J ( θ ) / ϑθ = 0$$

where J(θ) represents the target function value, θ represents the model parameter; and
performing parameter updates on the target NARX model based on the optimal model parameters to obtain the NARX model to be detected.

It should be understood that, the model parameters θ={β₀, β₁, β₂, . . . , βₙ, γ₁, γ₂, . . . , γₙ}, where β represents a coefficient of the autoregressive part of the NARX model, γ represents a coefficient of the exogenous input part of the NARX model, and β₀ represents the intercept. The parameter updates on the NARX model based on the optimal model parameters includes: replacing the coefficients of the autoregressive part, the coefficients of the exogenous input part, and the intercept of the NARX model with the optimal coefficients of the autoregressive part, the optimal coefficients of the exogenous input part, and the optimal intercept obtained by the derivative calculation, respectively.

In an embodiment, the method further includes: constructing the benchmark NARX model, including:
applying an excitation force to a defect-free specimen by the modal force hammer to induce a vibration phenomenon in the defect-free specimen, and performing signal collection on the defect-free specimen by the laser vibrometer to obtain an excitation signal corresponding to the excitation force applied to the defect-free specimen and a benchmark response signal corresponding to the vibration phenomenon in the defect-free specimen; and
importing the multiple order combinations; and constructing, according to the excitation signal corresponding to the excitation force applied to the defect-free specimen, the benchmark response signal and the multiple order combinations, initial benchmark NARX models corresponding to different orders; selecting, based on the Akaike information criterion, a target benchmark NARX model corresponding to the optimal order combination from the initial benchmark NARX models; and optimizing the target benchmark NARX model by the least squares method to obtain the benchmark NARX model.

In an embodiment, the comparing order information of the NARX model to be detected with order information of a benchmark NARX model to obtain an order comparison result, and determining, based on the order comparison result, whether there is a defect in the specimen to be detected includes:
extracting an order combination from the NARX model to be detected to obtain an autoregressive order to be detected and an exogenous input order to be detected, extracting an order combination from the benchmark NARX model to obtain a benchmark autoregressive order and a benchmark exogenous input order, calculating a difference between the autoregressive order to be detected and the benchmark autoregressive order to obtain an autoregressive order error, calculating a difference between the exogenous input order to be detected and the benchmark exogenous input order to obtain an exogenous order error, determining whether the autoregressive order error and the exogenous order error meet error thresholds respectively to obtain a determination result, and determining, based on the determination result, whether there is the defect in the specimen to be detected.

It should be understood that the order information in the NARX model refers to the optimal order combination. For example, the order information of the NARX model to be detected is the optimal order combination of the NARX model to be detected, that is, the order combination corresponding to the construction of the initial NARX model. The error threshold for the regression order error is different from the error threshold for the exogenous order error. If the specimen to be detected has the defect, it will often be reflected in the effects on the structure's stiffness, mass distribution, vibration modes, and other aspects, which may change the dynamic characteristics of the system, causing the model to require the order adjustment to better fit and predict the nonlinear dynamic response of the structure. Therefore, by judging the changes in the model order, it is possible to determine whether the specimen to be detected has the defect.

In the embodiment of the disclosure, by comparing the autoregressive orders and exogenous input orders of the NARX model to be detected for the defective specimen and the benchmark NARX model for the defect-free specimen, the residual of the parameter changes of the NARX model to be detected compared to the benchmark NARX model can be obtained. This can reveal the changes in the structural dynamic characteristics of the specimen to be detected when the defect is present, thereby achieving the purpose of defect detection.

As shown in FIG. 4, an embodiment of the disclosure provides a device for structural damage detection in a nonlinear system. The device includes a signal collection module, a model construction module, and a defect detection module.

The signal collection module is configured to apply an excitation force to a specimen to be detected by a modal force hammer to induce a vibration phenomenon in the specimen to be detected, and perform, when applying the excitation force, signal collection on the specimen to be detected by a laser vibrometer to obtain an excitation signal corresponding to the excitation force and a response signal corresponding to the vibration phenomenon in the specimen to be detected.

The model construction module is configured to import multiple order combinations; construct, according to the excitation signal, the response signal and the order combinations, initial NARX models corresponding to different orders; select, based on an Akaike information criterion, a target NARX model corresponding to an optimal order combination of the order combinations from the initial NARX models; and optimize the target NARX model by a least squares method to obtain a NARX model to be detected.

The defect detection module is configured to compare order information of the NARX model to be detected with order information of a benchmark NARX model to obtain an order comparison result, and determine, based on the order comparison result, whether there is a defect in the specimen to be detected.

It should be noted that, relational terms such as first and second herein are only used to distinguish one entity or operation from another, and do not necessarily require or imply any actual relationship or order between these entities or operations. Moreover, the terms “including”, “containing”, or any other variation thereof are intended to encompass non-exclusive inclusion, such that a process, method, item, or device including a series of elements includes not only those elements, but also other elements not explicitly listed, or elements inherent to such process, method, item, or device.

Those skilled in the art can clearly understand that for the convenience and simplicity of description, the specific working process of the device and modules described above can refer to the corresponding process in the aforementioned method embodiments, which will not be repeated here.

In the embodiments provided in the disclosure, it should be understood that the disclosed device and method can be implemented in other ways. For example, the device embodiments described above are only illustrative. For example, the division of modules is only a logical function division. In practical implementation, there may be other division methods, such as multiple modules or components being combined or integrated into another system, or some features being ignored or not executed.

The modules described as separate components may or may not be physically separated, and the components displayed as modules may or may not be physical modules, meaning they can be located in one place or distributed across multiple network modules. Some or all of the modules can be selected according to actual needs to achieve the purpose of the embodiments of the disclosure.

The above description is only an exemplary embodiment of the disclosure and is not intended to limit the disclosure. Any modifications, equivalent substitutions, improvements, etc. made within the spirit and principles of the disclosure should be included in the scope of protection of the disclosure.

What is claimed is:

1. A method for structural damage detection in a nonlinear system, comprising:
applying an excitation force to a specimen to be detected by a modal force hammer to induce a vibration phenomenon in the specimen to be detected, and performing, when applying the excitation force, signal collection on the specimen to be detected by a laser vibrometer to obtain an excitation signal corresponding to the excitation force and a response signal corresponding to the vibration phenomenon in the specimen to be detected;
importing a plurality of order combinations; constructing, according to the excitation signal, the response signal and the plurality of order combinations, initial nonlinear autoregressive with exogenous input (NARX) models corresponding to different orders;
selecting, based on an Akaike information criterion, a target NARX model corresponding to an optimal order combination of the plurality of order combinations from the initial NARX models;
and optimizing the target NARX model by a least squares method to obtain a NARX model to be detected; and
comparing order information of the NARX model to be detected with order information of a benchmark NARX model to obtain an order comparison result, and determining, based on the order comparison result, whether there is a defect in the specimen to be detected;
wherein the selecting, based on an Akaike information criterion, a target NARX model corresponding to an optimal order combination of the plurality of order combinations from the initial NARX models comprises:
acquiring parameters of the initial NARX models respectively to obtain model parameters of each of the initial NARX models, and performing calculation on the model parameters of each of the initial NARX models through a formula of the Akaike information criterion to obtain an Akaike information criterion value of each of the initial NARX models, wherein the formula of the Akaike information criterion is as follows:
$$AIC = 2 p - 2 ln ( L )$$
where AIC represents the Akaike information criterion value, p represents a number of the model parameters, and L represents a maximum likelihood estimation value; and
selecting one of the initial NARX models and the optimal order combination corresponding to a minimum value among the Akaike information criterion value of each of the initial NARX models to obtain the target NARX model corresponding to the optimal order combination;
wherein before the optimizing the target NARX model by a least squares method to obtain a NARX model to be detected, the method for structural damage detection further comprises:
solving, based on the model parameters of the target NARX model, the target NARX model to obtain a predicted response signal as follows:
$$\hat{y} ( k ; θ ) = {β}_{0} + {β}_{1} y ( k - 1 ) + … + {β}_{n} y ( k - {n}_{a} ) + {γ}_{1} u ( k - {n}_{b} ) + {γ}_{2} u ( k - {n}_{b} - 1 ) + … + {γ}_{n} u ( k - {n}_{b} - {n}_{k} )$$
where ŷ(k; θ) represents the predicted response signal, y(k) represents the response signal, u(k) represents the excitation signal, nₐ represents an autoregressive order, n_{b} represents a time delay, nₖ represents an exogenous input order, β₀ represents an intercept, βₙ represents an autoregressive coefficient, and γₙ represents an exogenous input coefficient;
wherein the optimizing the target NARX model by a least squares method to obtain a NARX model to be detected comprises:
performing calculation on the response signal and the predicted response signal of the target NARX model through a target function formula to obtain a target function value, wherein the target function formula is as follows:
$$J ( θ ) = {\sum }_{k = 1}^{N} {( y ( k ) - \hat{y} ( k ; θ ) )}^{2}$$
where J(θ) represents the target function value, y(k) represents the response signal, ŷ(k; θ) represents the predicted response signal, and N represents a total model parameter number; and
minimizing the target function value to obtain the NARX model to be detected.

2. The method for structural damage detection in the nonlinear system as claimed in claim 1, wherein each of the plurality of order combinations comprises the autoregressive order and the exogenous input order; and
wherein the constructing, according to the excitation signal, the response signal and the plurality of order combinations, initial NARX models corresponding to different orders comprises:
mapping, according to the autoregressive order and the exogenous input order of each of the plurality of order combinations, the excitation signal to the response signal to obtain a corresponding one of the initial NARX models to thereby obtain the initial NARX models as follows:
$$y ( k ) = F [ y ( k - 1 ) , … , y ( k - {n}_{a} ) , \\ u ( k - {n}_{b} ) , u ( k - {n}_{b} - 1 ) , … , u ( k - {n}_{b} - {n}_{k} ) ] + e ( k )$$
where y(k) represents the response signal, u(k) represents the excitation signal, F[⋅] represents a nonlinear function, nₐ represents the autoregressive order, n_{b} represents a time delay, nₖ represents an exogenous input order, and e(k) represents a model error term.

3. The method for structural damage detection in the nonlinear system as claimed in claim 1, wherein the minimizing the target function value to obtain the NARX model to be detected comprises:
performing derivative calculation on the target function value through a derivative equation to obtain optimal model parameters, wherein the derivative equation is as follows:
$$ϑ J ( θ ) / ϑθ = 0$$
where J(θ) represents the target function value, and θ represents the model parameter; and
performing parameter updates on the target NARX model based on the optimal model parameters to obtain the NARX model to be detected.

4. The method for structural damage detection in the nonlinear system as claimed in claim 1, further comprising:
constructing the benchmark NARX model, comprising:
applying an excitation force to a defect-free specimen by the modal force hammer to induce a vibration phenomenon in the defect-free specimen, and performing signal collection on the defect-free specimen by the laser vibrometer to obtain an excitation signal corresponding to the excitation force applied to the defect-free specimen and a benchmark response signal corresponding to the vibration phenomenon in the defect-free specimen; and
importing the plurality of order combinations; and constructing, according to the excitation signal corresponding to the excitation force applied to the defect-free specimen, the benchmark response signal and the plurality of order combinations, initial benchmark NARX models corresponding to different orders; selecting, based on the Akaike information criterion, a target benchmark NARX model corresponding to the optimal order combination from the initial benchmark NARX models; and optimizing the target benchmark NARX model by the least squares method to obtain the benchmark NARX model.

5. The method for structural damage detection in the nonlinear system as claimed in claim 1, wherein the comparing order information of the NARX model to be detected with order information of a benchmark NARX model to obtain an order comparison result, and determining, based on the order comparison result, whether there is a defect in the specimen to be detected comprises:
extracting an order combination from the NARX model to be detected to obtain an autoregressive order to be detected and an exogenous input order to be detected, extracting an order combination from the benchmark NARX model to obtain a benchmark autoregressive order and a benchmark exogenous input order, calculating a difference between the autoregressive order to be detected and the benchmark autoregressive order to obtain an autoregressive order error, calculating a difference between the exogenous input order to be detected and the benchmark exogenous input order to obtain an exogenous order error, determining whether the autoregressive order error and the exogenous order error meet error thresholds respectively to obtain a determination result, and determining, based on the determination result, whether there is the defect in the specimen to be detected.

6. A device for structural damage detection in a nonlinear system, comprising:
a signal collection module, configured to apply an excitation force to a specimen to be detected by a modal force hammer to induce a vibration phenomenon in the specimen to be detected, and perform, when applying the excitation force, signal collection on the specimen to be detected by a laser vibrometer to obtain an excitation signal corresponding to the excitation force and a response signal corresponding to the vibration phenomenon in the specimen to be detected;
a model construction module, configured to import a plurality of order combinations; construct, according to the excitation signal, the response signal and the plurality of order combinations, initial NARX models corresponding to different orders; select, based on an Akaike information criterion, a target NARX model corresponding to an optimal order combination of the plurality of order combinations from the initial NARX models; and optimize the target NARX model by a least squares method to obtain a NARX model to be detected; and
a defect detection module, configured to compare order information of the NARX model to be detected with order information of a benchmark NARX model to obtain an order comparison result, and determine, based on the order comparison result, whether there is a defect in the specimen to be detected;
wherein the select, based on an Akaike information criterion, a target NARX model corresponding to an optimal order combination of the plurality of order combinations from the initial NARX models comprises:
acquiring parameters of the initial NARX models respectively to obtain model parameters of each of the initial NARX models, and performing calculation on the model parameters of each of the initial NARX models through a formula of the Akaike information criterion to obtain an Akaike information criterion value of each of the initial NARX models, wherein the formula of the Akaike information criterion is as follows:
$$AIC = 2 p - 2 ln ( L )$$
where AIC represents the Akaike information criterion value, p represents a number of the model parameters, and L represents a maximum likelihood estimation value; and
selecting one of the initial NARX models and the optimal order combination corresponding to a minimum value among the Akaike information criterion value of each of the initial NARX models to obtain the target NARX model corresponding to the optimal order combination;
wherein before the optimize the target NARX model by a least squares method to obtain a NARX model to be detected, the model construction module is further configured to perform the following steps:
solving, based on the model parameters of the target NARX model, the target NARX model to obtain a predicted response signal as follows:
$$\hat{y} ( k ; θ ) = {β}_{0} + {β}_{1} y ( k - 1 ) + … + {β}_{n} y ( k - {n}_{a} ) + {γ}_{1} u ( k - {n}_{b} ) + {γ}_{2} u ( k - {n}_{b} - 1 ) + … + {γ}_{n} u ( k - {n}_{b} - {n}_{k} )$$
where ŷ(k; θ) represents the predicted response signal, y(k) represents the response signal, u(k) represents the excitation signal, nₐ represents an autoregressive order, n_{b} represents a time delay, nₖ represents an exogenous input order, β₀ represents an intercept, βₙ represents an autoregressive coefficient, and yₙ represents an exogenous input coefficient;
wherein the optimize the target NARX model by a least squares method to obtain a NARX model to be detected comprises:
performing calculation on the response signal and the predicted response signal of the target NARX model through a target function formula to obtain a target function value, wherein the target function formula is as follows:
$$J ( θ ) = {\sum }_{k = 1}^{N} {( y ( k ) - \hat{y} ( k ; θ ) )}^{2}$$
where J(θ) represents the target function value, y(k) represents the response signal, ŷ(k; θ) represents the predicted response signal, and N represents a total model parameter number; and
minimizing the target function value to obtain the NARX model to be detected.

7. The device for structural damage detection in the nonlinear system as claimed in claim 6, wherein each of the plurality of order combinations comprises the autoregressive order and the exogenous input order; and
wherein the construct, according to the excitation signal, the response signal and the plurality of order combinations, initial NARX models corresponding to different orders comprises:
mapping, according to the autoregressive order and the exogenous input order of each of the plurality of order combinations, the excitation signal to the response signal to obtain a corresponding one of the initial NARX models to thereby obtain the initial NARX models as follows:
$$y ( k ) = F [ y ( k - 1 ) , … , y ( k - {n}_{a} ) , \\ u ( k - {n}_{b} ) , u ( k - {n}_{b} - 1 ) , … , u ( k - {n}_{b} - {n}_{k} ) ] + e ( k )$$
where y(k) represents the response signal, u(k) represents the excitation signal, F[⋅] represents a nonlinear function, nₐ represents the autoregressive order, n_{b} represents the time delay, nₖ represents the exogenous input order, and e(k) represents a model error term.
